(19) United States
(12) Patent Application Publication
(10) Pub. No.: US 2020/0372463 A1
(43) Pub. Date: Nov. 26, 2020

(54) METHOD AND SYSTEM FOR DELIVERING AND/OR COLLECTING OBJECTS AT A PLACE OF DESTINATION

(71) Applicant: Ford Global Technologies, LLC, Dearborn, MI (US)

(72) Inventor: Frederic Stefan, Aachen (DE)

(73) Assignee: Ford Global Technologies, LLC, Dearborn, MI (US)

(21) Appl. No.: 16/881,445

(22) Filed: May 22, 2020

(30) Foreign Application Priority Data
May 24, 2019 (DE) 102019207641.6

(51) Int. Cl. G06Q 10/08; B64C 39/02; H04W 4/021

(52) U.S. Cl. CPC G06Q 10/08355; G06Q 10/0832; B64C 2201/141; H04W 4/021; B64C 2201/128; B64C 39/024

(57) ABSTRACT

The disclosure relates to a method for delivering and/or collecting an object at a place of destination (2) by means of a vehicle (3), with automatic determining by an electronic control device (4) on-board the vehicle whether the vehicle (3) has reached a predetermined local area (8) of the place of destination (2), whereupon a notification is automatically generated at the place of destination (2) relating to the arrival of the vehicle (3) by means of a communication device (7) at the place of destination. It is characterized in that the vehicle (3) is stopped in the local area (8) of the place of destination (2) and the object to be delivered and/or collected is handed over from and/or into the vehicle (3). The disclosure further relates to a system (1) for delivering and/or collecting an object at a place of destination (2) by means of a vehicle (3).

### CROSS-REFERENCE TO RELATED APPLICATIONS

The present application claims priority to and the benefit of German Application No. 102019207641.6, filed May 24, 2019, which is hereby incorporated by reference herein in its entirety.

### FIELD

The present application relates to a method and a system for delivering and/or collecting an object at a place of destination by means of a vehicle.

### BACKGROUND

Common applications in the mobility domain relate to the delivery and/or collection of objects (also referred to generally herein below as mobility interaction), for example persons or goods, by means of a vehicle, such as, for example, a passenger vehicle, truck and the like. For this purpose, the vehicle normally moves to a previously defined delivery or collection address, where said vehicle parks—even if only briefly—in a parking space or at least in a suitable parking area to avoid obstructing flowing traffic if possible. Locating a parking space of this type can be very time-consuming, can consequently incur additional costs, and furthermore often represents a wearing, stressful activity for a vehicle driver. In some situations, no suitable parking space can even be found for the vehicle within an acceptable time period, so that an unavoidable parking of the vehicle in the traffic area of the flowing traffic results in traffic situations which are perceived by other road users as highly irritating, for example in narrow streets.

After parking the vehicle, the driver of the vehicle normally leaves the vehicle in order to announce his arrival at the destination address, for example by ringing the doorbell at a building entrance, for example in order to pick up a person or collect or deliver a package. The driver then returns to his vehicle and continues his journey with the vehicle.

A method and a system for automatic authorization of access to an entrance door by means of an Internet-enabled device of a user desiring entry are known, for example, from DE 10 2015 210 025 A1.

DE 10 2005 057 101 A1 shows a method and a central device for controlling access to secured areas or facilities by means of a mobile device which is assigned to a user.

DE 10 2014 004 673 A1 discloses a method for depositing a consignment in a motor vehicle, wherein the motor vehicle is opened to deposit the consignment only in the event of a detected matching of authentication information stored in the vehicle and affixed to the consignment.

### SUMMARY

Against this background, the object of the present disclosure is to provide an improved method and system for delivering and/or collecting an object at a place of destination by means of vehicle, said method enabling the delivery and/or collection of the object, for example a person, a package, merchandise and the like, on the whole significantly more time-efficiently (and therefore likewise cost-efficiently), and also substantially less stressfully for any persons involved in the mobility interaction.

This object is achieved by a method with the features of claim 1 and by a system with the features of claim 7. The respective subclaims disclose further, particularly advantageous designs of the disclosure.

It should be noted that the features described individually in the claims can be combined with one another in any technically appropriate manner and represent further designs of the disclosure. The description characterizes and specifies the disclosure, in particular additionally in connection with the figures.

It should further be noted that an “and/or” conjunction used herein below, appearing between and interlinking two features, is to be interpreted as meaning that only the first feature may be present in a first design of the subject-matter according to the disclosure, only the second feature may be present in a second design, and both the first and the second feature may be present in a third design.

According to the disclosure, a method for delivering and/or collecting an object at a place of destination by means of a vehicle (which is also referred to generally herein as a mobility interaction or interaction for short) entails at least the following steps, wherein the sequence of the steps to be performed is not necessarily restricted to the sequence listed below:
defining a geographical position of the place of destination;
providing the defined geographical position to an electronic control device on-board the vehicle;
moving the vehicle in the direction of the defined geographical position of the place of destination;
automatically determining, by means of the electronic control device on-board the vehicle, whether the vehicle has reached a predefined local area of the place of destination;
when the vehicle has reached the local area of the place of destination, automatic signaling, to a communication device at the place of destination, of the arrival of the vehicle in the local area by the electronic control device on-board the vehicle by means of a wireless communication device on-board the vehicle controlled by said control device;
following the reception of the arrival signaling by the communication device at the place of destination, automatically generating a notification at the place of destination of the arrival of the vehicle by means of an electronic control device at the place of destination controlling the communication device at the place of destination;
stopping the vehicle in the local area of the place of destination; and
handing over the object which is to be delivered and/or collected from and/or into the vehicle.

The geographical position of the place of destination which may, for example, be a building contains, for example, a normal address with town, street and/or house number details, geographical coordinates (e.g. GPS coordinates) and the like. The electronic control device on-board the vehicle can be designed, in particular, as an electronic computing and/or memory unit, i.e. having one or more processors (e.g. microprocessor, microcontroller, DSP and the like) and one or more memory components (e.g. RAM, ROM, flash, magnetic memories and the like). The vehicle can preferably be a land vehicle, for example a passenger vehicle, transporter, bus, truck, etc., which is suitable for transporting persons and goods. However, the disclosure is not necessarily restricted to land vehicles, but can similarly comprise aircraft, for example drones, insofar as they are suitable for delivering and/or collecting an object at a place of destination within the meaning of the present disclosure. Objects to be delivered and/or collected may, in particular, be persons or goods, merchandise, packages and the like. The movement of the vehicle toward the previously defined place of destination or to the defined geographical position of the place of destination can be performed through human control, i.e. by a person controlling the vehicle, or autonomously or partially autonomously, i.e. at least partially or even fully computer-controlled.

The geographical position of the place of destination can be defined directly by a person from a telephone call (e.g. ordering a taxi), a computer-supported, automatic speech recognition or a computer-supported text recognition (e.g. a written text message, such as, for example, SMS) and the like. The geographical position can furthermore also be defined on the basis of mobility interactions of the vehicle already previously carried out for the delivery and/or collection of an object at a place of destination, i.e. based on previously known historical data relating thereto, whereby a merchandise/package identification or person recognition is automatically carried out, for example by means of a sensor/scanner (e.g. digital camera, barcode scanner, RFID, NFC and like), and the place of destination or the geographical position thereof is then automatically determined and therefore defined from the identification result.

The defined geographical position can be provided to the electronic control device on-board the vehicle which is disposed in the vehicle at least during the performance of the method according to the disclosure, in particular can also be permanently connected to or integrated into the vehicle, via a human-machine interface (HMI interface) known per se, for example a keypad, touchscreen and the like, insofar as it is provided by a person. The geographical position can also be provided automatically to the control device on-board the vehicle, i.e. directly via electronic means, particularly if the geographical position has already been determined in advance in an all-electronic, computer-supported manner, as described above on the basis of examples.

Along with the geographical position of the place of destination, further information relating to the delivery and/or collection of the object at the place of destination can preferably also be provided, for example the class of the interaction which is to be performed, i.e. “delivery” or “collection”, the interaction object, i.e. “person” or “merchandise/goods”, and a communication network which is to be used for the communication between the wireless communication device on-board the vehicle and the communication device at the place of destination, for example the Internet, mobile radio (GSM, LTE, etc.), WLAN and the like, and, if necessary, an access password for access to the communication network, for example an Internet access password, WLAN password, telephone number, etc.

In the case of a line-connected communication network which is to be used, such as, for example, line-connected Internet, the communication device at the place of destination may be an Internet router. In the case of a wireless communication network which is to be used (mobile radio, WLAN, etc.), the communication device at the place of destination may accordingly be a wireless communication device.

During the movement of the vehicle in the direction of the place of destination (i.e. the journey of the vehicle to the place of destination) for the delivery and/or collection of an object, the electronic control device on-board the vehicle determines whether the vehicle has reached the predefined local area of the place of destination. This determination can be performed and repeated automatically at predefined time intervals, for example once per minute, or can also comprise a longer time period of several minutes, e.g. 3, 5 or 10 minutes. The local area of the place of destination is to be understood here to mean a geographical area around the place of destination or the geographical position thereof which comprises a radius of, for example, a maximum of 100 meters or less, e.g. 75 m, 50 m, 25 m or 10 m, or at most a few hundred meters up to at most one or at most a few kilometers, for example 1, 2, 3 or 5 km.

As soon as the vehicle has reached the local area of the place of destination, the control device on-board the vehicle automatically signals the arrival of the vehicle in the local area by means of the wireless communication device on-board the vehicle to the communication device at the place of destination. The optionally previously defined communication network and/or access password/telephone number can be used for this purpose. If no communication network and/or access password is defined in advance, default specifications can also be used for this purpose. The signaling may be a simple message, for example in text form such as SMS, or a telephone call.

Following the reception of the arrival signaling by the communication device at the place of destination, the electronic control device at the place of destination which can preferably be designed as an electronic computing and memory unit, i.e. having one or more processors (e.g. microprocessors, microcontrollers, DSPs and the like) and one or more memory components (e.g. RAM, ROM, flash, magnetic memories and the like), generates a notification at the place of destination relating to the arrival of the vehicle. This notification may, for example, be in the form of a text message displayed on a screen, a voice message, a text message (e.g. SMS) sent to a mobile device (e.g. cell phone, smartphone, etc.), a bell signal, for example of a building intercom system and the like.

Following the signaling by the control device on-board the vehicle indicating the arrival of the vehicle in the local area of the place of destination, the vehicle is stopped in the local area of the place of destination. The vehicle can be stopped in the local area directly at the geographical position of the place of destination, but is not necessarily restricted to the exact geographical position and can be stopped within the radius essentially defining the local area.

After the vehicle has stopped, the object is handed over between the place of destination and the vehicle. This means, for example, that a person transported in the vehicle gets out of the vehicle or a person to be transported gets into said vehicle and/or one or more packages, merchandise and the like are loaded from or into the vehicle.

The essential advantage of the method according to the disclosure is that the vehicle does not have to be parked in a special parking space prior to the handover of the object between the place of destination and the vehicle. The vehicle can be stopped briefly at an essentially suitable place, since the object can be handed over relatively quickly, in particular without a driver of the vehicle (in the case of a human-controlled vehicle) getting out and subsequent searching by the driver in person for the geographical position of the place of destination. The handover of the object can therefore be performed substantially more time-efficiently. A traffic hindrance by the delivering or collecting vehicle is avoided or at least reduced to a minimum time period. The interaction for the persons involved herein can furthermore be performed in a substantially less stressful manner, in particular for a driver of the vehicle, since said driver does not have to take great trouble to find a suitable parking space to park the vehicle.

As already mentioned above, the previously listed sequence of the steps according to the disclosure does not necessarily have to be followed. Instead, for example, the signaling of the arrival of the vehicle in the local area of the place of destination by the control device on-board the vehicle and the generating of the notification at the place of destination by the control device at the place of destination can equally be performed after the vehicle has stopped in the local area.

Optionally, the completion of the delivery and/or collection of the object at the place of destination can additionally be detected automatically, in particular by the control device on-board the vehicle. The entry of a person and/or the depositing of a package/merchandise, etc. in the vehicle can be detected by means of a digital camera or other suitable sensor (e.g. barcode scanner, QR code scanner, NFC, RFID, GPS, etc.) by the control device on-board the vehicle. The alighting of a person and/or the removal of a package/merchandise, etc. from the vehicle can similarly be detected automatically in this way.

Alternatively or additionally to the automatic detection, a human-machine interface (HMI interface) known per se, for example a keypad, touchscreen and the like, can be provided, particularly in the vehicle, in order to indicate manually also the completion of the delivery and/or collection of the object at the place of destination.

According to a further advantageous design of the disclosure, the wireless communication device on-board the vehicle and/or the communication device at the place of destination has/have only one local area communication zone, wherein the local area of the place of destination is defined by the spatial area of a duly performed, two-way information transmission between the wireless communication device on-board the vehicle and the communication device at the place of destination. In other words, the local area is inherently predefined by the local area communication zone of at least one wireless communication device, since no duly performed, two-way information exchange is possible between the two communication devices outside the local area communication zone. It is to be understood that, if the communication device at the place of destination is also intended to have a local area communication zone, said device is designed as a wireless communication device. Depending on the communication network used for the communication between the wireless communication device on-board the vehicle and the (wireless) communication device at the place of destination, e.g. WLAN, the local area communication zone and therefore the local area of the place of destination can have a radius of a maximum of a few meters up to a few hundred meters or even up to a maximum of one or a maximum of a few kilometers. A local area having a radius around the place of destination or the geographical position thereof of a maximum of approximately between 100 m and 300 m is particularly preferred. Due to the inherent definition of the local area around the place of destination as a consequence of the local area communication zone of at least one of the two communication devices, a local area zone otherwise to be additionally defined if necessary around the respective place of destination is advantageously no longer required.

According to a further advantageous design of the disclosure, the local area of the place of destination is defined by means of a predeterminable spatial and/or predeterminable temporal distance from the vehicle to the geographical position of the place of destination. The temporal distance represents the estimated time of arrival of the vehicle at the geographical position of the place of destination or the remaining time period until this position is reached. A navigation device, for example, which is coupled with the electronic control device on-board the vehicle can be used to define the local area radius around the place of destination or the geographical position thereof. In this way, the local area around the place of destination can be defined more precisely and more flexibly than, for example, via the local area communication zone of a wireless communication device.

Another further advantageous design of the disclosure provides that an estimated time of arrival of the vehicle at the place of destination is determined by the electronic control device on-board the vehicle during the movement of the vehicle in the direction of the defined geographical position of the place of destination, wherein the determined time of arrival is transmitted from the control device on-board the vehicle to the electronic control device at the place of destination by means of the communication devices on-board the vehicle and at the place of destination. The estimated time of arrival at the place of destination can be indicated or notified in this way by the control device at the place of destination, so that any preparations can be carried out in advance before the actual performance of the mobility interaction (object handover). The mobility interaction can thus be performed on the whole even more time-efficiently overall.

A navigation device on-board the vehicle, for example, can be used to determine the estimated time of arrival. The communicated estimated time of arrival may be an absolute time or an estimated time period until the arrival of the vehicle at the place of destination. The estimated time of arrival can be determined once only or repeatedly at defined time intervals, for example once every minute or once every few minutes, during the movement of the vehicle, and can then be transmitted to the place of destination. The estimated time of arrival can first be determined and/or communicated to the place of destination after the vehicle has first begun to move following the definition of the geographical position of the place of destination. The control device on-board the vehicle can, for example, monitor the operational state of an engine driving the vehicle, an ignition switch, a speed or a minimum speed of the vehicle, a certain maximum time period following the definition and provision of the geographical position and the like, and can evaluate said operational state in terms of a state which indicates the start of the mobility interaction.

According to a further advantageous design of the disclosure, the movement of the vehicle in the direction of the defined geographical position of the place of destination can be controlled partially autonomously or fully autonomously. In other words, the vehicle is no longer fully human-controlled or is not at all human-controlled in this design.

Another further advantageous design of the disclosure provides that the handover of the object to be delivered and/or collected between the vehicle and the place of destination is performed within the local area of the place of destination by means of an aircraft, for example a drone, controlled by the electronic control device at the place of destination. In this way, the spatial distance between the actual stopping point of the vehicle in the local area of the place of destination and the geographical position of the place of destination can be bridged in a time-efficient manner. Furthermore, the radius of the local area of the place of destination can, if necessary, be chosen as significantly greater, which may be advantageous, particularly in densely populated areas. The control device at the place of destination can generate the corresponding control commands for the aircraft, so that said aircraft can unerringly reach the vehicle. To do this, the control device on-board the vehicle can communicate precise location information relating to the actual stopping point of the vehicle in the local area of the place of destination in advance to the control device at the place of destination.

The commands to be generated to activate or control the aircraft can be generated by the electronic control device at the place of destination during the generation of the notification at the place of destination relating to the arrival of the vehicle in the local area. They can also be generated automatically from the content of the previously generated notification (e.g. text message indicating the precise vehicle stopping point).

According to a further aspect of the disclosure, a system is disclosed for delivering and/or collecting an object at a place of destination by means of a vehicle, wherein the system has the vehicle which in turn has an electronic control device on-board the vehicle which controls a wireless communication device on-board the vehicle, and further has a communication device at the place of destination controlled by an electronic control device at the place of destination, said communication device being configured to exchange information with the wireless communication device on-board the vehicle. According to the disclosure, the electronic control device on-board the vehicle is configured to receive a previously defined geographical position of the place of destination, to determine automatically, when the vehicle moves in the direction of the defined geographical position of the place of destination, whether the vehicle has reached a local area of the place of destination, and, if the vehicle has reached the local area of the place of destination, to signal the arrival of the vehicle in the local area automatically to the communication device at the place of destination by means of the wireless communication device on-board the vehicle. The electronic control device at the place of destination is further configured, following the reception of the arrival signaling via the communication device at the place of destination, to automatically generate a notification at the place of destination relating to the arrival of the vehicle.

With regard to system-related definitions of terms and the effects and advantages of features according to the method, reference is made in full to the above explanations of corresponding definitions, effects and advantages relating to the method according to the disclosure. Disclosures herein relating to the method according to the disclosure are intended to be applied in a corresponding manner to the definition of the system according to the disclosure also, unless this is expressly excluded herein. Similarly, disclosures herein relating to the system according to the disclosure are intended to be applicable to the definition of the method according to the disclosure, unless this is similarly expressly excluded herein. In this respect, explanations of correspondingly similar features, their effects and advantages relating to the method according to the disclosure disclosed herein and the system according to the disclosure disclosed herein are largely not repeated in the interests of a more concise description.

According to one advantageous design of the disclosure, the place of destination is a building, for example a house, residential building, business and the like. In such a case, the electronic control device at the place of destination can preferably be a control device controlling a door communication system or intercom system of the building. In this way, the arrival of the vehicle can be notified in a particularly simple manner, for example by the automatic generation of a bell signal. The control device or intercom system at the place of destination can be extended for this purpose, for example with the communication device at the place of destination, which can also be designed as a wireless communication device.

Another further advantageous design of the disclosure provides that the electronic control device at the place of destination is configured, following the reception of the arrival signaling, to transmit confirmation information (receive acknowledgement) relating to the reception of the arrival signaling via the communication device at the place of destination to the wireless communication device on-board the vehicle.

According to another further advantageous design of the disclosure, the wireless communication device on-board the vehicle and/or the communication device at the place of destination further has/have only one local area communication zone, wherein the local area of the place of destination is defined by the spatial area of a duly performed, two-way information transmission between the wireless communication device on-board the vehicle and the communication device at the place of destination.

According to another further design of the disclosure, the system can further preferably have a navigation device (in particular a satellite-based navigation device) on-board the vehicle connected in an information-transmitting manner to the electronic control device on-board the vehicle, both devices being configured to define the local area of the place of destination by means of a predeterminable spatial and/or predeterminable temporal distance from the vehicle to the geographical position of the place of destination.

A further preferred design of the disclosure provides that the vehicle is a partially autonomously or fully autonomously controlled vehicle.

According to another further advantageous design of the disclosure, an aircraft (e.g. a drone) controllable by the electronic control device at the place of destination is provided which is configured to hand over the object to be delivered and/or collected within the local area of the place of destination between the place of destination and the vehicle.

### BRIEF DESCRIPTION OF THE DRAWING

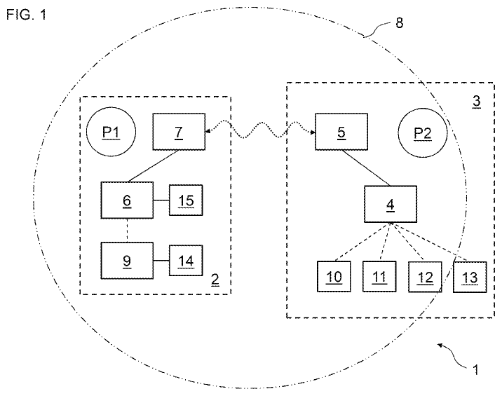

Further features and advantages of the disclosure are set out in the following description of one example embodiment of the disclosure which is to be understood as non-limiting and which is explained in detail below with reference to the drawing. In this drawing, the single FIGURE (FIG. 1) shows one example embodiment of a system according to the disclosure.

### DETAILED DESCRIPTION

FIG. 1 shows a schematic view of a system 1 for delivering and/or collecting an object (not shown) at a place of destination 2, in the present instance, by way of example, a building, by means of a vehicle 3, here a land vehicle, which may be autonomous, partially autonomous or human-controlled. The vehicle 3 has an electronic control device 4 on-board the vehicle which controls a wireless communication device 5 on-board the vehicle. An electronic control device 6 at the place of destination which controls a communication device 7 at the place of destination which is similarly designed in the present instance as a wireless communication device is provided at the place of destination 2. As indicated in FIG. 1, both communication devices 5 and 7 are configured to exchange information with one another. A local area 8 of the place of destination 2 is merely implicitly indicated in FIG. 1.

A door communication system or intercom system 9 which is coupled with the control device 6 at the place of destination is further provided in the example embodiment shown in FIG. 1 of the system 1 at the place of destination 2. However, this is not absolutely necessary for the disclosure. The vehicle 3 shown in FIG. 1 similarly has further components which are not necessarily to be provided, for example an HMI interface 10, a navigation device 11 (in particular a satellite-based navigation device such as GPS), a digital camera 12, a scanner 13 (e.g. barcode scanner, QR code scanner, RFID scanner and the like).

As shown in FIG. 1, the place of destination 2 or the building 2 of the system 1 shown by way of example similarly has further components not necessarily required for the disclosure, e.g. a bell 14 for audible signaling (in particular also of the arrival of the vehicle 3 in the local area 8 of the place of destination 2), which can be controlled by the intercom system 9 or, in the present instance, also indirectly via the control device 6 at the place of destination, and a screen 15 to display notifications generated by the control device 6 (visual signaling).

The system 1 shown in FIG. 1 could, for example, be used for the following example application:

a first person P1 present in his home 2 is intended to be picked up by a second person P2 with the vehicle 3 (mobility interaction). The person P2 uses, for example, his smartphone and an app running thereon to perform this mobility interaction (in this case, the smartphone of the person P2 can correspond to the electronic control device 4 on-board the vehicle shown in FIG. 1, and the app can correspond to the HMI interface 10), or a control device 4 permanently installed in the vehicle 3 having an HMI interface 10. The mobility interaction to be performed is defined by the person P2 by inputting the geographical position (address) of the place of destination 2 (home of P1), the “collect” interaction class of the “person” interaction object and the communication network, for example a WLAN of the place of destination 2 or a home automation system assigned to the building 2, and a password to access the WLAN communication network of the place of destination 2. Instead of the WLAN communication network, for example, a mobile radio/GSM network can also be defined as the communication network and a cell phone number of the person P1 can be stored in the control device 4 on-board the vehicle. If a mobile radio network is chosen as the communication network to be used, the control device 6 at the place of destination, including the screen 15, can correspond to a smartphone of the person 1. In both cases described above (WLAN or GSM), the communication device 7 at the place of destination is a wireless communication device (corresponding to a WLAN or GSM).

The control device 4 on-board the vehicle can optionally configure the navigation device 11 provided in the present example automatically, but said device could similarly be configured manually via the HMI interface 10. The mobility interaction is then started by moving the vehicle 3 in the direction of the place of destination 2.

After the control device 4 has detected the start of the mobility interaction, it calculates the estimated time of arrival of the vehicle 3 at the place of destination 2 or in the local area 8 of the place of destination 2, wherein, if a WLAN network is selected as the communication network, said local area can be defined inherently by the maximum range of the WLAN network. The estimated time of arrival can be transmitted from the control device 4 on-board the vehicle to the control device 6 (e.g. smartphone of P1) at the place of destination.

Alternatively or additionally, the control device 4 can transmit the time of arrival onto a central data server (not shown) also, from which the person P1 can similarly retrieve the estimated time of arrival.

As soon as the vehicle 3 has reached the local area 8 of the place of destination 2 (e.g. the range of the WLAN network at the place of destination, or spatial and/or temporal determination by the navigation device 11), the control device 4 on-board the vehicle signals the arrival of the vehicle 3 in the local area 8 of the place of destination 2 to the control device 6 at the place of destination. The arrival signaling can be performed, for example, by transmitting a corresponding message or by means of a telephone call to the person P1.

The control device 6 at the place of destination can optionally transmit back a confirmation (receive acknowledgement) following the reception of the arrival signaling from the control device 4 on-board the vehicle.

In each case, the control device 6 at the place of destination generates a notification at the place of destination 2 (e.g. by signaling a telephone call or a text message on the smartphone of P1 or by displaying a text message on the screen 15 or by generating a bell signal by means of the bell 14, etc.). The person P1 then leaves the building 2. The person P2 stops the vehicle 3 in the local area 8 of the building 2. The person P1 reaches and enters the vehicle 3, which can be detected here for, example, by the camera 12 on-board the vehicle. In addition, further sensors (not shown) which are provided in the vehicle 3 can detect when the person P1 is seated on the front passenger seat and when the front passenger seat safety belt is fastened. This additional information (validation information) is used by the control device 4 on-board the vehicle to automatically determine the end of the mobility interaction (pick-up of person P1).

The method according to the disclosure disclosed herein and the system according to the disclosure disclosed herein for delivering and/or collecting an object at a place of destination by means of a vehicle are not restricted to the embodiments in each case disclosed herein, but also comprise similarly acting further embodiments which are derived from technically appropriate further combinations of the features described herein of both the method and the system. In particular, the features and feature combinations mentioned above in the general description and in the description of the figures of the present disclosure and/or shown in the figures alone are usable not only in the respectively indicated combinations, but also in other combinations or in isolation without departing the scope of the present disclosure.

In a particularly preferred embodiment, both the method according to the disclosure and the system according to the disclosure for delivering and/or collecting objects, in particular persons and/or merchandise/goods, at a place of destination, in particular a building, by means of a vehicle, such as, for example, single-track or multi-track, motorized land vehicles, e.g. a motorcycle, motor scooter, passenger vehicle, taxi, rental vehicle, car-sharing vehicle, van, transporter, truck, minibus or omnibus and the like are used.

### REFERENCE NUMBER LIST

1 System
2 Place of destination
3 Vehicle
4 Electronic control device on-board the vehicle
5 Wireless communication device on-board the vehicle
6 Electronic control device at the place of destination
7 Communication device at the place of destination
8 Local area
9 Door communication/intercom system
10 HMI interface
11 Navigation device
12 Camera
13 Scanner
14 Bell
15 Screen
P1 First person
P2 Second person

What is claimed is:

1. A method for delivering and/or collecting an object at a place of destination (2) by a vehicle (3), the method comprising:
defining a geographical position of the place of destination (2);
providing the geographical position to an electronic control device (4) on-board the vehicle;
moving the vehicle (3) in a direction of the geographical position of the place of destination (2);
automatically determining, by the electronic control device (4) on-board the vehicle, whether the vehicle (3) has reached a local area (8) of the place of destination (2);
when the vehicle (3) has reached the local area (8) of the place of destination (2), automatic signaling, to a communication device (7) at the place of destination, an arrival of the vehicle (3) in the local area (8) by the electronic control device (4) on-board the vehicle by a wireless communication device (5) on-board the vehicle controlled by the electronic control device (4);
following reception of the signaling by the communication device (7) at the place of destination (2), automatically generating a notification at the place of destination of the arrival of the vehicle (3) by an electronic control device (6) at the place of destination controlling the communication device (7) at the place of destination;
stopping the vehicle (3) in the local area (8) of the place of destination (2); and
handing over the object which is to be delivered and/or collected from and/or into the vehicle (3).

2. The method of claim 1, wherein the wireless communication device (5) on-board the vehicle and/or the communication device (7) at the place of destination has/have only one local area communication zone and the local area (8) of the place of destination (2) is defined by a spatial area of a duly performed, two-way information transmission between the wireless communication device (5) on-board the vehicle and the communication device (7) at the place of destination.

3. The method of claim 1, wherein the local area (8) of the place of destination (2) is defined by a predetermined spatial and/or predetermined temporal distance from the vehicle (3) to the geographical position of the place of destination (2).

4. The method of claim 1, wherein an estimated time of arrival of the vehicle (3) at the place of destination (2) is determined by the electronic control device (4) on-board the vehicle during a movement of the vehicle (3) in the direction of the defined geographical position of the place of destination (2), wherein the determined time of arrival is transmitted from the control device (4) on-board the vehicle to the electronic control device (6) at the place of destination by the communication devices (5, 7) on-board the vehicle and at the place of destination.

5. The method of claim 1, wherein a movement of the vehicle (3) in the direction of the defined geographical position of the place of destination (2) is controlled partially autonomously or fully autonomously.

6. The method of claim 1, wherein the handing over of the object to be delivered and/or collected between the vehicle (3) and the place of destination (2) is performed within the local area (8) of the place of destination (2) by an aircraft, for example a drone, controlled by the electronic control device (6) at the place of destination.

7. A system for delivering and/or collecting an object at a place of destination (2) by a vehicle (3), the system comprising:
an electronic control device (4) on-board the vehicle which controls a wireless communication device (5) on-board the vehicle, and
a communication device (7) at the place of destination controlled by an electronic control device (6) at the place of destination, said communication device (7) being configured to exchange information with the wireless communication device (5) on-board the vehicle,
wherein the electronic control device (4) on-board the vehicle is configured:
to receive a previously defined geographical position of the place of destination (2),
to determine automatically, when the vehicle (3) moves in the direction of the defined geographical position of the place of destination (2), whether the vehicle (3) has reached a local area (8) of the place of destination (2), and
if the vehicle (3) has reached the local area (8) of the place of destination (2), to signal the arrival of the vehicle (3) in the local area (8) automatically to the communication device (6) at the place of destination by the wireless communication device (5) on-board the vehicle,
wherein the electronic control device (6) at the place of destination is configured, following the reception of the arrival signaling by the communication device (7) at the place of destination, to automatically generate a notification at the place of destination (2) relating to the arrival of the vehicle (3).

8. The system of claim 7, wherein the place of destination (2) is a building.

9. The system of claim 7, wherein the electronic control device (6) at the place of destination is a control device controlling a door communication system (9) of the building (2).

10. The system of claim 7, wherein the electronic control device (6) at the place of destination is configured, following the reception of the arrival signaling, to transmit confirmation information relating to the reception of the arrival signaling via the communication device (7) at the place of destination to the wireless communication device (5) on-board the vehicle.

11. The system of claim 7, wherein the wireless communication device (5) on-board the vehicle and/or the communication device (7) at the place of destination has/have only one local area communication zone and the local area (8) of the place of destination (2) is defined by the spatial area of a duly performed, two-way information transmission between the wireless communication device (5) on-board the vehicle and the communication device (7) at the place of destination.

12. The system of claim 7, wherein a navigation device (11) on-board the vehicle connected in an information-transmitting manner to the electronic control device (4) on-board the vehicle, both devices being configured to define the local area (8) of the place of destination (2) by a predeterminable spatial and/or predeterminable temporal distance from the vehicle (3) to the geographical position of the place of destination (2).

13. The system of claim 7, wherein the vehicle (3) is a partially autonomously or fully autonomously controlled vehicle.

14. The system of claim 7, wherein an aircraft controllable by the electronic control device (6) at the place of destination which is configured to hand over the object to be delivered and/or collected within the local area (8) of the place of destination (2) between the place of destination (2) and the vehicle (3).
